(19) United States
(12) Patent Application Publication
(10) Pub. No.: US 2010/0318472 A1
(43) Pub. Date: Dec. 16, 2010

(54) BETA-TARGETED INVESTMENT FUND

(76) Inventor: Eric Falkenstein, Eden Prairie, MN (US)

Correspondence Address: SCHWEGMAN, LUNDBERG & WOESSNER, P.A., P.O. BOX 2938, MINNEAPOLIS, MN, 55402, US

(21) Appl. No.: 12/482,178

(22) Filed: Jun. 10, 2009

(51) Int. Cl. G06Q 40/00

(52) U.S. Cl. 705/36 R

(57) ABSTRACT

A beta-targeted portfolio is managed by receiving historical beta information regarding a plurality of stocks, and transforming the historical beta information regarding the plurality of stocks into a purchasing decision regarding at least one of the plurality of stocks based on the at least one stock's anticipated future beta. Selected stocks having approximately a desired anticipated future beta matching a desired beta of the portfolio are purchased to form a beta-targeted portfolio.

### FIELD OF THE INVENTION

The invention relates generally to finance and investing, and more specifically to a beta-targeted investment fund.

### BACKGROUND

Directing use of one's resources so that they may realize some greater benefit in the future than the resources would provide if they were consumed today is broadly known as investing. An investor typically hopes that the resources invested will make a profit, or will provide a gain that rewards the investor for the time the resources are invested and the risk that the expected reward may not materialize.

Today, most adults have significant investments in financial instruments such as their 401(k) or IRA retirement accounts, savings accounts, and other such financial vehicles. Other investments such as a home may not have the same expectation for increase in value, but may provide other benefits to the investor such as providing a place to live. The investor typically balances factors such as expected return, risk of not achieving the expected rate of return, tolerance for risk, and diversity of assets among a portfolio of investments in allocating investment resources. Much research has been done on optimizing the rate of return for a portfolio while incurring no more risk than necessary, so that risk-adjusted returns are maximized.

Today, most portfolio analytics for well-researched portfolios such as mutual funds use what is known as the Capital Asset Pricing Model (CAPM) to determine the rate of return that is to be expected for bearing a certain level of risk. More specifically, the CAPM uses a supposed risk-free rate of return such as a United States Treasury Bond to establish the base return, which then increases as a linear function of beta, which is a measure of an asset's (or portfolio's) covariance with the market, divided by the variance of that market. This is known as the security market line. In this theory any portfolio or individual investment can then be characterized using the line by either finding the expected reward on the line and finding the corresponding risk as reflected by the beta, or finding a tolerable level of risk on the line and finding the expected reward.

Measurement of reward is reasonably straightforward, and is typically based on the expected increase in value of an asset over a period of time, accounting for dividends or interest. Risk is somewhat harder to characterize, but in the CAPM risk is calculated based on the volatility of a specific investment relative to a broad market.

By far the most common measure of risk is the beta coefficient, often simply called beta, which describes the sensitivity of an asset's returns to the return of the broad market as a whole, as measured say by the S&P500 index. More generally, the beta is a measure of volatility relative to a market, such that an asset that is approximately 1.5 times as volatile as the market as a whole will have a beta of approximately 1.5, or a nondiversifiable risk of 1.5.

While the empirical relation of beta to returns is the subject of considerable debate, beta remains the most common measure of “risk”, or “market risk” of a portfolio, and makes comparison of a stock's volatility and correlation relative to a larger market fairly straightforward. The widespread availability of beta information for a wide variety of stocks makes beta a useful tool in evaluating the market risk associated with various stocks. Many investors consider beta a very useful practical measure of risk in equity investing.

### SUMMARY

One example embodiment of the invention comprises managing a beta-targeted fund by receiving historical beta information regarding a plurality of stocks, and transforming the historical beta information regarding the plurality of stocks into a purchasing decision regarding at least one of the plurality of stocks based on at least one stock's anticipated future beta. Selected stocks having approximately a desired anticipated future beta matching a desired beta of the portfolio are purchased to form a beta-targeted portfolio.

In a further example, a portfolio is formed by selling (going short) a high beta fund and buying (going long) a low beta fund, resulting in a low or zero beta portfolio having positive alpha relative to the market. In another example, a beta-targeted fund having a beta such as 1.0 excludes high beta stocks anticipated to have lower-than-average returns, providing a fund having approximately the same movement of the overall market while providing higher returns than a market index fund.

### BRIEF DESCRIPTION OF THE FIGURES

FIG. 1a shows betas of stocks larger than the market capitalization of the median stock by percentile for the years 1962-2008.

FIG. 1b shows betas of stocks larger than the market capitalization of the median stock by percentile for the years 2000-2008.

FIG. 2a illustrates calculation of an adjustment factor E based on true beta β* and the measured beta β̂, as used in an example embodiment of the invention.

FIG. 2b illustrates estimation of true beta β* based on historic daily data, consistent with an example embodiment of the invention.

FIG. 2c illustrates estimation of true beta β* based on historic monthly data, consistent with an example embodiment of the invention.

FIG. 3 is a table of historic returns of various beta-targeted portfolios from 1962-2009, consistent with an example embodiment of the invention.

FIG. 4a shows historical monthly betas of various stocks over the past 36 to 60 months in deciles tabbed against the historical daily betas of the same stocks over the past 270 days broken into deciles, with observed month-ahead monthly betas indicated in the crosstab elements, consistent with an example embodiment of the invention.

FIG. 4b shows historical monthly betas of various stocks over the past 36 to 60 months in deciles tabbed against the historical daily betas of the same stocks over the past 270 days broken into deciles, with observed month-ahead daily betas indicated in the crosstab elements, consistent with an example embodiment of the invention.

FIG. 5 illustrates returns of a portfolio implementing a strategy anticipating reversion to the mean of stocks having significant movement in a preceding day, consistent with an example embodiment of the invention.

FIG. 6 shows the beta estimated using the formula of 0.38 times past monthly plus 0.72 times past daily betas to predict future beta, versus actual future beta observed, consistent with an example embodiment of the invention.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

As previously discussed, beta is often used as a means of characterizing risk or volatility, and is a common means of comparing similar assets or judging the relative risk of assets referenced against a broader market. A mutual fund that produces a 10% return per year with a beta of 0.9 relative to a broad market index is generally considered a more prudent investment than a similar fund that produces a 10% return per year with a beta of 1.3, as the same return is being achieved with less market risk. Hedge funds may similarly attempt to reduce or limit the risk they incur by reducing the beta of their portfolios relative to a broad market index, ensuring that the fund manager does not seek high returns by trading in highly volatile stocks and taking greater than acceptable risk.

Risk mitigation can be achieved by evaluating the beta of various assets in the portfolio relative to the reference market, and ensuring that the asset betas of the assets approximately accumulate to the desired portfolio beta. For example, a bundle of relatively high beta assets such as small company stocks might be offset by stocks in consumer staples that have a relatively low beta. But, betas of various assets are constantly changing and assets are bought and sold in most such portfolios daily, making tracking the beta of a portfolio difficult.

Broadening a portfolio of assets to resemble a broader market will tend to move the beta towards 1, making the risk of the portfolio substantially market risk rather than undiversifiable or systematic risk. In such diversified portfolios, beta represents the risk that cannot be diversified out by inclusion of the asset in a large portfolio, or the systematic risk of the asset.

Other statistical measures are often used in evaluating suitable investments, such as alpha, which measures the return beyond the expected return of an asset using the beta coefficient methods described above. Alpha is really a residual, that return outside the ‘risk adjusted return’. Alpha is achieved through the special skill of the investor, and is generally more expensive because to the extent an asset manager is believed to generate it, he is basically offering the investor a riskless return. If two portfolios have similar betas, indicating similar risk or market sensitivity, but a first has an alpha (residual return) of 0 while the second has an alpha of 2%, it can be concluded that the first pays the investor only for the risk borne while the second pays the investor for the risk borne plus some fraction of the additional alpha return, making the second portfolio a more desirable investment. While in general portfolio managers try to convince investors they have positive alpha, the average of all investor alpha must be zero by the laws of mathematics; everyone can not be above average.

While some mutual funds such as index funds attempt to mimic broader markets, anticipating a beta of approximately one and an alpha of approximately zero, they do so by including a range of stocks having betas and alphas representative of the distribution of such stocks in the broader market. Hedge funds usually offer portfolios that are both long and short equities, emphasizing their positive alpha, and try to keep their beta exposure near zero. Index funds are based on the idea that attempts to generate alpha are generally not effective, and concentrate on having a low cost, diversified portfolio that generates the market return. Their attractiveness comes from being efficient, as opposed to being prescient, and they typically charge a fraction of one percent of invested assets as a management fee given the mathematical simplicity in selecting appropriate investments. In contrast, hedge funds often charge 2% of assets per year as a management fee and keep 20% of profits realized, because they are selling alpha while minimizing if not eliminating market risk (i.e., beta near zero). Hedge fund investors therefore expect positive alpha for their higher fees as compensation for the additional expenses incurred.

Although the Capital Asset Pricing Model (CAPM) and its concepts such as alpha and beta are industry standards and won Bill Sharpe and Harry Markowitz the Nobel Prize in 1990, some embodiments of the invention discard the concept that beta is positively correlated with return. More specifically, in the standard theory funds with a beta of one are generally considered to have no beta risk relative to the reference market, as they should approximately replicate the return of the market used as a benchmark. Although a fund having a beta of 0.5 and a fund having a beta of 1.5 both deviate from the “safe” beta of 1.0 by 0.5, the traditional CAPM suggests that the 0.5 beta is safer than the 1.5 beta fund, because it has a lower volatility, but should return less than either the market or the beta 1.5 portfolio, as less “market risk” is taken.

Some embodiments of the invention presented here are based on the observation that beta and expected return are not positively correlated as is suggested by the CAPM, and further, that that low beta stocks will in aggregate and over time provide slightly higher returns than high beta stocks. Low beta stocks, in a CAPM model, have positive alpha. Use of various targeted beta funds, including certain targeted beta funds having assets with intended negative alphas, can be used to generate alpha returns while mathematically minimizing or eliminating beta or market risk from the fund.

Research suggests that assets on the extreme ends of the risk spectrum produce lower-than-average returns, including both high beta and low beta stocks. High beta stocks often have what can be considered a “hope” premium added to their price; that is, they have a higher-than-justified price due to their perceived chances of doubling or more, and their relative attractiveness to investors aggressively chasing high returns. Similarly, assets with very high certainty have lower-than-average returns, as some investors are willing to pay a premium for the sense of security that comes with owning what are perceived to be the least risky assets available in a market.

In one embodiment of the invention, a fund such as a mutual fund or exchange traded fund (ETF) can be assembled having a targeted beta, such as 0.5, relative to a broad market. Given the premise (n contrast to what is implied by the CAPM) that high beta stocks are on average no better performers over time than high beta stocks, a fund in a further embodiment is constructed of stocks selected for their future potential for higher than average returns, or for high alpha, such as a fund having a targeted beta of 1 that excludes stocks having high betas above 1.5. That is, one can achieve a beta of 1 two ways, by buying the market, including low and high beta assets, or only those stocks with betas near 1.0, excluding the low and high beta stocks. The latter will have a higher return, but same market risk, as the former portfolio if higher and/or low beta stocks generally underperform.

In another example, a first fund is constructed of stocks such that the fund has a low beta, such as 0.5, and a second fund is constructed having a high beta such as 1.5. In a further embodiment, the stocks making up the high beta fund are either known to have a lower than average likelihood of providing high returns due to their “hope” premium discussed earlier, and may be further selected based on other criteria for their anticipated probability of underperforming the market.

Using high and low beta funds such as these, a portfolio is assembled with a long position in the low beta fund and a short position in the high beta fund, thereby producing a portfolio with a beta of approximately zero. The long and short positions are bought in proportion to the betas to produce a net portfolio with a beta of zero, such as 0.5 units of the 1.5 beta portfolio and 1.5 units of the 0.5 beta portfolio. If the betas of the two funds are different or the desired target beta is not zero, the amount of each fund held can be adjusted proportionately to ensure that the desired portfolio beta is still achieved.

For example, consider a hedge fund manager who has assembled or has access to a fund of stocks having an unusually low beta of 0.5, but who wishes his portfolio to be beta-neutral so that the portfolio's performance cannot be attributed to correlation with the market return but is attributable to the alpha of the stocks that make up the portfolio. The beta of the portfolio can be adjusted by shorting a beta-targeted portfolio having a beta of 2.0 using 20% of the fund's assets (0.5 units of beta 2.0 and 2 units of beta 0.5), thereby resulting in a portfolio beta of zero. This involves a gross amount of 2.5 units invested. In this example, by shorting a fund with a beta of 2.0 instead of the beta 1.5 portfolio of the previous example, the fund manager is able to dedicate only 20% of the fund's gross assets to his short. In contrast, shorting with index funds with a beta of 1.0 would imply a gross amount of money as 3 units, and so 33% of the funds gross assets would be allocated to his short. The short is a net drag on fund performance, and so the strategy with high beta short is more efficient.

In some embodiments such as the preceding example, higher beta portfolios are therefore used, such as a beta of 1.75, 2.0, 2.5, etc., further minimizing the percentage of fund assets that must be invested in shorting the high beta portfolio to balance the beta of the overall portfolio. Because it is more difficult to maintain a diverse portfolio of stocks whose beta differs greatly from the overall market's beta, there will be practical limits to the betas that can be effectively targeted with reasonable accuracy.

In another embodiment, the high beta portfolio is bought long rather than shorted, but contains shorted equities or their equivalents, forming the equivalent of sorting the high beta portfolio in the above example. Other equivalents to short and long positions can be constructed using options, futures, and other such financial tools, such as where high deviation from a market's beta is desired to minimize the amount of a fund needed to be beta-neutral in a portfolio.

In examples where the stocks in the funds are broadly selected to create a diversified portfolio having the targeted beta, a form of beta-based return arbitrage generates return while being beta neutral. For example, consider the earlier portfolio having a long position of 1.5 units of a first ETF with a beta of 0.5 and a short position of 0.5 shares in a second ETF with a beta of 1.5, forming a portfolio with a net beta of 1.0. The portfolio can therefore be considered to be a “beta neutral” portfolio with what would traditionally be termed to be no “market risk” relative to the market overall.

The portfolio just constructed is not expected to have returns equal to market returns, however, given the observation in some embodiments of the invention that high beta stocks do not generally result in higher returns as is predicted by modern portfolio theory and the capital asset pricing model but in fact have lower returns over time than lower beta stocks. The above portfolio has therefore shorted 0.5 units of stocks that are expected to underperform and is long 1.5 units of stocks that are expected to outperform, desirably resulting in outperformance of the market with no beta risk relative to the market. Further, the position is net long 1.0 units of stocks, and to the extent there is a general equity premium, reaps this premium with no beta risk. This beta arbitrage enables greater-than-market returns while bearing no more risk than the market as a whole using the traditional market risk measure of beta.

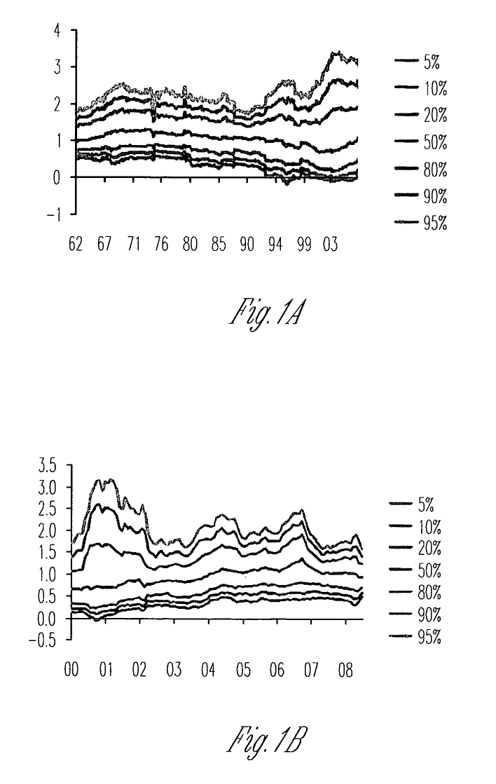

Designing a fund with a certain beta requires ready availability of a suitably broad range of stocks having approximately the desired beta, and some understanding of the volatility and movement of the beta of the portfolio and the underlying equities. Further, although betas for a given market are always one by definition, the range of betas of the individual stocks can vary significantly. FIG. 1a shows betas of stocks larger than the market capitalization of the median stock by percentile for the years 1962-2008, showing a significant broadening in beta of larger stocks since 1990. This suggests that predicting beta distributions within a market is not straightforward, and can vary significantly over time. For example, betas of stocks with market capitalizations over $500M have converged over the past eight years, as shown in FIG. 1b.

It therefore becomes important for the manager of a targeted beta fund to be aware of changes in beta of assets in a portfolio, and of the beta characteristics of the market as a whole, so that the targeted beta can be reasonably closely achieved going forward. In one example, betas can be estimated going forward using monthly, daily, or other interval pricing data or beta data, or such data can be combined in attempting to best predict forward beta. Further, as betas vary about a mean of 1.0 and betas varying significantly from the mean tend to revert over time back toward the mean.

Efforts at targeting a specific beta are further complicated in that traditional CAPM pricing model betas are traditionally calculated using data over the past year or longer in academic literature. These calculations are again complicated by the fact that betas can be calculated different ways, using daily, or monthly returns, and using various sample periods (e.g. the last year vs. the last three years).

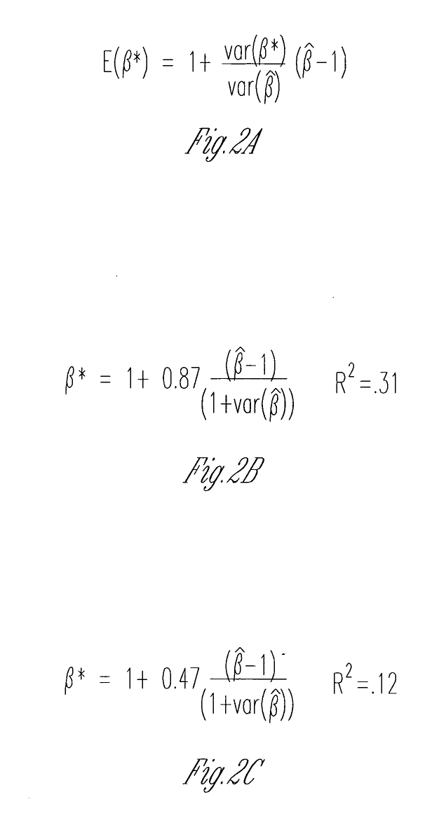

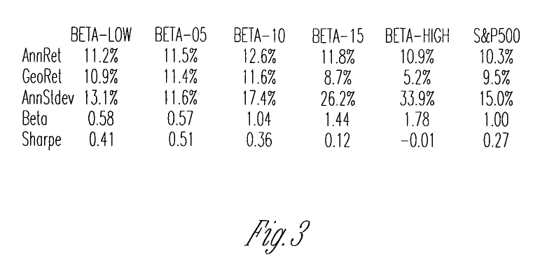

In calculating beta, consideration of the likely error involved in calculation and the tendency of betas of individual equities to revert to the mean, or 1.0, suggests that measured beta will have a larger variance than true beta. One such Bayesian adjustment to beta is given in FIG. 2a, in which the true beta β* and the measured beta β̂ are used to calculate an adjustment factor E. Bloomberg, for example, elects to report betas by scaling the measured beta by 0.66 and adding 0.33, reducing the variance in reported beta significantly from what is measured.

Using historical betas to predict the next month's betas using daily beta data from the preceding month, linear regression suggests the true beta β* is best fit for the sample data by the coefficients of the equation of FIG. 2b. Using historical monthly data to predict the next month's data, the true beta β* is best fit by the coefficients of the equation in FIG. 2c. A higher coefficient of determination (R²) and smaller coefficient on the historical beta estimate in the daily data equation of FIG. 2b suggests prior daily beta data is a significantly better single indicator of future monthly beta than prior monthly beta data as evaluated in FIG. 2c.

FIG. 3 is a table showing the returns to various portfolios grouped by their betas. This used the investable universe, which was assumed to have a lower bound at the twentieth percentile of the NYSE listed firms. As Nasdaq and AMEX firms are generally smaller, this gets rid of about half of the stocks actually listed, but it is more realistic in that it corresponds to about a $500MM market capitalization cut-off. Most institutional investors are wary of going much below this because it gets difficult to put on large positions, and using the percentile we can account for the upward drift in the average market capitalization of this period.

Data were taken from 1962 through March 2009. Only monthly data were used prior to 2000, but subsequent to that this was combined with daily return data, so that the beta estimates are better in the more recent period. Nonetheless, the older betas are instructive for purposes of analyzing the relation between beta and return.

In the table, we see that average arithmetic annual returns are highest for the Beta-1.0 stocks. This portfolio contains only those stocks were the prospective beta forecast is closest to a beta of 1.0, thus trimming off the higher and lower beta equities. The beta 0.5, and beta 1.5, equivalently targeted those numbers. Over this period, we see the average beta actually experience by these portfolios was closer to one, reflecting some of the ineradicable mean reversion in beta. Nonetheless, they were relatively close to their beta targets. The high and low beta portfolios, meanwhile, were merely the 100 most extreme projected betas, and these betas varied considerably over the 47 year period.

The table shows that returns are clearly not increasing in terms of beta, and so this suggests several interesting investing strategies. This becomes even clearer when one uses geometric returns as opposed to arithmetic returns, because arithmetic returns are for someone investing a fixed amount, each month, whereas the geometric return is for the buy-and-hold investor, the latter being more relevant to the longer term investor. These returns really fall off for the higher beta portfolios.

Because this sample selected from about 1500 stocks, it tended to have a more equal-weighted bias than the S&P500, which is value weighted. As smaller stocks strongly outperformed larger stocks in this period, the average return among all these portfolio is higher than for the S&P500. Yet the Beta 1.0 portfolio generates a good 100 basis point lift relative to this effect, highlighting that the Beta 1.0 portfolio, by excluding the low-returning, high beta stocks, dominates the index with the same beta.

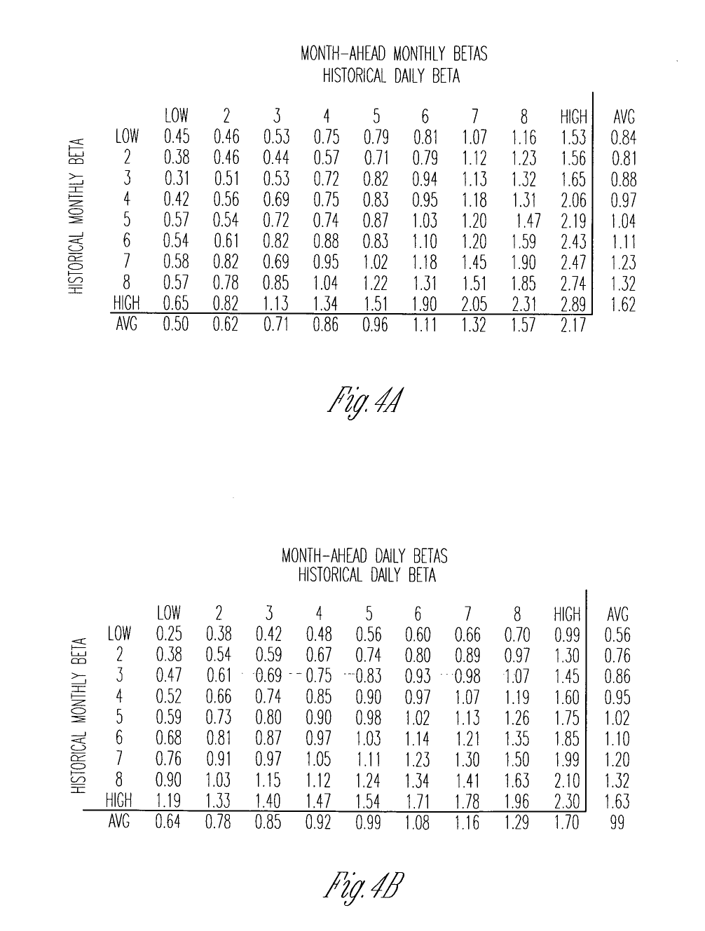

An evaluation of monthly and daily betas is presented in the crosstab tables of FIGS. 4a-b, which show the month-ahead monthly beta observed based on a combination of historical monthly beta by decile and historical daily beta by decile. More specifically, looking at FIG. 4a, the historical monthly betas of various stocks over the past 36 to 60 months are broken into deciles on the vertical axis, and the historical daily betas of the same stocks over the past 270 days are broken into deciles on the horizontal axis. The average observed month-ahead beta relative to the S&P 500 for stocks falling in each of the hundred crosstabs is shown in the cells of the crosstab.

The data in the crosstab of FIG. 4a shows that although historical daily beta is a stronger predictor of future beta than average monthly beta, stocks having some given average daily beta do vary significantly in future beta depending on their historical monthly beta. Stocks having a high historical monthly and daily beta have higher future betas than stocks having a high historical daily beta but lower historical monthly betas, just as stocks having low historical daily betas and low historical monthly betas have lower future betas than stocks having low historical daily betas and high historical monthly betas.

As FIG. 4b shows, the difference is even more stark when month-ahead daily betas are crosstabbed, and month-ahead daily betas typically vary over a wider range than the month-ahead monthly betas observed in the crosstab cells of FIG. 4a. This reinforces the idea that although daily betas are a better single predictor of future beta than monthly betas, both monthly and daily historical beta of stocks are useful in predicting future betas of stocks, whether over the next days or months.

To observe the strong influence of reversion to the mean on a portfolio of high beta and low beta stocks, such a portfolio is constructed in one example by taking the highest 30% of daily betas and the lowest 30% of monthly beta stocks, and anticipating a reversion to the mean of a beta of one using stocks with a market capitalization of more than $500 million based on movement over the prior two days. If a stock is up more than one percent over the prior two days the stock is shorted, and if the stock is down more than one percent over the prior two days it is purchased long. The resulting return over time is shown in the chart of FIG. 6 which illustrates that since 2000 such a portfolio returns an annualized return of 34% and a standard deviation of 18%.

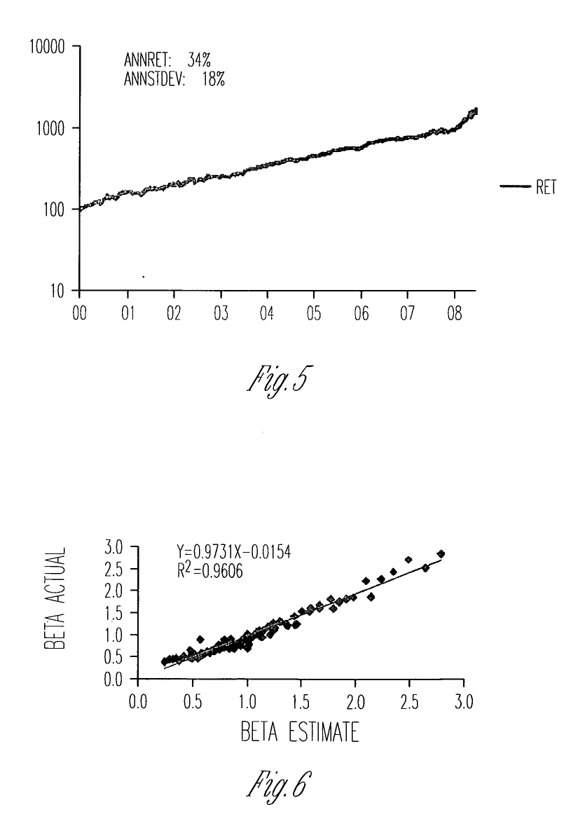

Here, the average daily return is approximately 0.13%, and the holding period for each equity is only one day, so the transaction costs of implementing such an investing strategy would likely have a significant impact on actual profitability of such a portfolio. As FIG. 5 shows, the pattern of returns has remarkable stability over a particularly volatile period in stock market history, and indicates that reversion to the mean is a very real and predictable phenomenon. When applied to beta forecasting, this suggests that an estimate of future betas based on past betas may be more accurate by including some anticipated reversion from extreme betas toward the mean beta value of one.

Using the month-ahead betas observed in FIGS. 4a and 4b, regression indicates that month-ahead betas are best predicted using a formula of approximately 0.38 times the historical monthly beta over the prior 36-60 months plus 0.72 times the historical daily beta observed over the last 270 days. Although such a formula appears to suggest that one is always using 110% of historical betas to predict future beta, the formula results in very high betas only where the average monthly and average daily betas are both very high, which is consistent with the future betas observed in FIGS. 4a and 4b.

FIG. 6 shows the beta estimated using the formula of 0.38 times past monthly plus 0.72 times past daily betas to predict future beta, versus actual future beta observed. Here the R² is 0.96, indicating that the formula is a very good predictor of future beta as shown by the clustering of data points near the straight line in the graph. This suggests that future betas can be predicted reasonably well, enabling a beta-targeted fund to be effectively constructed from stocks having approximately the desired fund beta with reasonable accuracy based on observed past beta data for the equities considered for inclusion in the targeted beta fund.

Knowing that high beta stocks do not on average produce higher returns than low beta stocks, and knowing that future beta can be reasonably estimated to produce beta-targeted mutual funds or exchange-traded funds, an investor can use various strategies to manage beta in a portfolio to control the portfolio's correlation to the market. If expected returns of various beta portfolios are all substantially similar rather than based on some risk premium above a risk-free rate of return, high beta portfolios can be used as a more cost effective hedge than an index fund or other lower beta fund. For example, 1.5 times the S&P 500 has a higher expected return and costs 1.5 times more than a beta 1.5 portfolio, making the high beta portfolio a more cost efficient hedge than the S&P 500 index fund.

In one example, a beta 0.5 fund and a beta 1.5 fund both provide an expected return of 10%, which is essentially the same return expected from a broader market, such as the S&P500. An investor assembles a portfolio by buying 3 units of a beta 0.5 fund, and by shorting one unit of a beta 1.5 fund. This yields a net portfolio of zero beta and a return equal to approximately the 10% return of the three long units minus the 10% loss of the shorted unit, yielding ((3*10%)−10%)/2 units, or 10% per unit.

Given that Reg. T requires one have gross long and short positions no more than twice one's capital, capital sufficient to purchase 1.5 units long, and 0.5 units short, generates a 10% return per dollar of capital with a beta of zero rather than the market beta of one that would normally be realized in buying an index fund. Further, if the shorted 1.5 beta hedge underperforms the beta 0.5 longs, due to the “hope” premium observed with high beta stocks, the expected return of the portfolio can be significantly higher than 10% of capital invested while still having approximately zero beta.

If a portfolio of stocks having beta of 1.5 or higher has a lower return than an index such as the S&P500, due to a “hope” premium, reversion to the mean, or for any other reason, a beta 1.0 portfolio derived from the same market of stocks that includes equities expected to have a future beta of approximately 1.0 and excludes a group of beta 1.5 and above lower-than-average stocks will have a higher expected return than the market, but will have the same beta, or “risk” as the market. This provides an attractive alternative to an index fund, as an investor bears no more risk or volatility than the market as a whole but realizes a greater expected return than an index fund would provide by excluding stocks whose betas suggest lower-than-average returns. This return premium may be only a percent or two, but such small differences are what underlie the attractiveness of index funds, which merely propose a cost savings of under a percentage point due to their low cost focus. In the context of index funds, a trimmed 1.0 beta portfolio (trimming the high and low beta stocks from the portfolio) is an attractive investment.

The examples shown here illustrate how targeted beta investment funds can be used to create funds that are suitable for hedging a portfolio, or that can be combined to be beta-neutral or to have other beta characteristics as desired. It has been shown that high beta stocks do not necessarily produce higher returns than low beta stocks, and a high beta portfolio of stocks selected for their likelihood to lose value can be shorted as a cost-effective hedge in a hedge fund or other portfolio. Predictability of future beta based on past observed betas over periods of days and months has shown that a combination of short-term and long-term observed betas provide a very good estimate of future beta. Other factors, such as extreme moves in the market, have been examined and their impact on future betas considered in how to most effectively construct a targeted beta portfolio that yields the desired beta.

Although specific embodiments have been illustrated and described herein, it will be appreciated by those of ordinary skill in the art that any arrangement that achieve the same purpose, structure, or function may be substituted for the specific embodiments shown. Various embodiments include different methods of determining a numerical target beta, such as receiving a numerical target determined by a fund manager or calculating a target based on other information. Matching stocks to a numerical target beta, achieving a numerical target beta, and producing a portfolio having a targeted beta using beta-targeted funds can all be achieved with various tolerances, such as 0.05, 0.1, 0.15, 0.2, 0.3, or 0.5 beta tolerance or a similar percent tolerance.

Further, various algorithms and methods disclosed herein may be practiced via electrical circuits, computer systems programmed to perform the algorithm or method to achieve a desired result, or other means including electronic manipulation of data representing physical quantities or other real-world data. Various elements of may be practiced in modules, including various combinations of software, hardware, and human interaction. This application is intended to cover any adaptations or variations of the example embodiments of the invention described herein. It is intended that this invention be limited only by the claims, and the full scope of equivalents thereof.

1. A method of managing a beta-targeted fund comprising executing instructions on a computing system to:
receive historical beta information regarding a plurality of stocks;
determine a numerical beta target for the beta-targeted fund; and
transform the historical beta information regarding the plurality of stocks into a purchasing decision regarding at least one of the plurality of stocks based on the anticipated future betas of the plurality of stocks;
wherein selected stocks having approximately a desired anticipated future beta matching the numerical beta target for the fund are purchased to form a beta-targeted fund.

2. The method of managing a beta-targeted fund of claim 1, wherein the beta-targeted fund comprises a high beta fund having a desired beta of 1.5.

3. The method of managing a beta-targeted fund of claim 2, wherein the high beta fund is configured to have a lower return than a market used to calculate beta, thereby configured to be a more efficient hedge.

4. The method of managing a beta-targeted fund of claim 1, wherein the beta-targeted fund comprises a low beta fund having a desired beta of 0.75 or less.

5. The method of managing a beta-targeted fund of claim 1, wherein a beta-managed portfolio is assembled by shorting a beta-targeted fund having a high beta and buying long a beta-targeted fund having a low beta.

6. The method of managing a beta-targeted fund of claim 5, wherein the beta-managed portfolio has a net beta of approximately zero, but is dollar long.

7. The method of managing a beta-targeted portfolio of claim 1, wherein transforming the historical beta information regarding the plurality of stocks into a purchasing decision based on the at least one stock's anticipated future beta comprises calculating anticipated future beta based on historical beta over one or more periods of time.

8. A computerized system configured to:
receive historical beta information regarding a plurality of stocks;
determine a numerical beta target for a beta-targeted fund;
transform the historical beta information regarding the plurality of stocks into a purchasing decision regarding at least one of the plurality of stocks based on the anticipated future betas of the plurality of stocks;
wherein selected stocks having approximately a desired anticipated future beta matching the numerical beta target are purchased to form the beta-targeted fund.

9. The computerized system of claim 1, wherein the beta-targeted fund comprises a high beta portfolio having a desired beta of 1.5.

10. The computerized system of claim 9, wherein the high beta fund is configured to have a lower return than a market used to calculate beta.

11. The computerized system of claim 8, wherein the beta-targeted fund comprises a low beta portfolio having a desired beta of 0.75 or less.

12. The computerized system of claim 8, wherein a beta-managed portfolio is assembled by shorting a beta-targeted fund having a high beta and buying long a beta-targeted fund having a low beta.

13. The computerized system of claim 12, wherein the high beta fund is configured to underperform the low beta fund, increasing the return of the beta-managed portfolio.

14. The computerized system of claim 12, wherein the beta-managed portfolio has a beta of approximately zero.

15. The computerized system of claim 8, wherein transforming the historical beta information regarding the plurality of stocks into a purchasing decision based on the at least one stock's anticipated future beta comprises calculating anticipated future beta based on historical beta over one or more periods of time.

16. A machine-readable medium with instructions stored thereon, the instructions when executed on a computerized system operable to cause the system to:
receive historical beta information regarding a plurality of stocks;
determine a numerical beta target for a beta-targeted fund; and
transform the historical beta information regarding the plurality of stocks into a purchasing decision regarding at least one of the plurality of stocks based on the at least one stock's anticipated future beta;
wherein selected stocks having approximately a desired anticipated future beta matching the numerical beta target for the fund are purchased to form the beta-targeted fund.

17. A method of managing a beta-targeted fund comprising executing instructions on a computing system to:
receive historical beta information regarding a plurality of stocks; and
transform the historical beta information regarding the plurality of stocks into a purchasing decision regarding at least one of the plurality of stocks based on the at least one stock's anticipated future beta;
wherein selected stocks having approximately an anticipated future beta of 1.0 are purchased to form a beta-targeted fund having a beta of approximately 1.0, thereby excluding high beta stocks anticipated to have lower-than-average returns.

18. The method of managing a beta-targeted fund of claim 17, wherein selected stocks having approximately an anticipated future beta of 1.0 are within 0.05, 0.1, 0.15, 0.2, 0.3, 0.4 or 0.5 of beta 1.0.

19. A computerized system configured to:
receive historical beta information regarding a plurality of stocks; and
transform the historical beta information regarding the plurality of stocks into a purchasing decision regarding at least one of the plurality of stocks based on the at least one stock's anticipated future beta;
wherein selected stocks having approximately an anticipated future beta of 1.0 are purchased to form a beta-targeted fund having a beta of approximately 1.0, thereby excluding high beta stocks anticipated to have lower-than-average returns.

20. The computerized system of claim 19, wherein selected stocks having approximately an anticipated future beta of 1.0 are within 0.05, 0.1, 0.15, 0.2, 0.3, 0.4 or 0.5 of beta 1.0.
